(19) United States
(12) Patent Application Publication
(10) Pub. No.: US 2013/0080174 A1
(43) Pub. Date: Mar. 28, 2013

(54) RETRIEVING DEVICE, RETRIEVING METHOD, AND COMPUTER PROGRAM PRODUCT

(71) Applicants: Osamu Nishiyama, Kanagawa (JP); Nobuhiro Shimogori, Kanagawa (JP); Tomoo Ikeda, Tokyo (JP); Kouji Ueno, Kanagawa (JP); Hirokazu Suzuki, Tokyo (JP); Manabu Nagao, Kanagawa (JP)

(72) Inventors: Osamu Nishiyama, Kanagawa (JP); Nobuhiro Shimogori, Kanagawa (JP); Tomoo Ikeda, Tokyo (JP); Kouji Ueno, Kanagawa (JP); Hirokazu Suzuki, Tokyo (JP); Manabu Nagao, Kanagawa (JP)

(73) Assignee: KABUSHIKI KAISHA TOSHIBA, Tokyo (JP)

(21) Appl. No.: 13/527,763

(22) Filed: Jun. 20, 2012

(30) Foreign Application Priority Data
Sep. 22, 2011 (JP) 2011-208051

(51) Int. Cl. G10L 13/00

(52) U.S. Cl. 704/260; 704/E13.001

(57) ABSTRACT

In an embodiment, a retrieving device includes: a text input unit, a first extracting unit, a retrieving unit, a second extracting unit, an acquiring unit, and a selecting unit. The text input unit inputs a text including unknown word information representing a phrase that a user was unable to transcribe. The first extracting unit extracts related words representing a phrase related to the unknown word information among phrases other than the unknown word information included in the text. The retrieving unit retrieves a related document representing a document including the related words. The second extracting unit extracts candidate words representing candidates for the unknown word information from a plurality of phrases included in the related document. The acquiring unit acquires reading information representing estimated pronunciation of the unknown word information. The selecting unit selects at least one of candidate word of which pronunciation is similar to the reading information.

### CROSS-REFERENCE TO RELATED APPLICATION(S)

This application is based upon and claims the benefit of priority from Japanese Patent Application No. 2011-208051, filed on Sep. 22, 2011; the entire contents of which are incorporated herein by reference.

### FIELD

Embodiments described herein relate generally to a retrieving device, a retrieving method, and a computer program product.

### BACKGROUND

In the related art, various techniques for improving the efficiency of a transcribing operation of extracting a text from voice data have been known. For example, a technique of retrieving phrases having similar pronunciation using information representing an estimated pronunciation (reading) of a phrase of which the pronunciation is not correctly understood and of which the notation (spelling) is unclear is known. For example, a technique is known in which a phoneme symbol string input by the user is corrected in accordance with a predetermined rule to generate a corrected phoneme symbol string, and phoneme symbol strings identical or similar to the generated corrected phoneme symbol string are retrieved from a spelling table in which a plurality of sets of a spelling and a phoneme symbol string is stored in correlation to thereby retrieve the spelling of the corrected phoneme symbol string.

However, in the techniques of the related art, since phrases are retrieved based on only the degree of similarity of pronunciation, phrases which are not relevant to the context of a text to be transcribed may also be displayed as the retrieval result.

### BRIEF DESCRIPTION OF THE DRAWINGS

FIG. 1 is a block diagram illustrating a schematic configuration example of a retrieving device according to an embodiment;

FIG. 2 is a flowchart illustrating an example of the processing operation by the retrieving device according to the embodiment;

FIG. 3 is a flowchart illustrating an example of a candidate word extracting process according to the embodiment;

FIG. 4 is a flowchart illustrating an example of a selecting process according to the embodiment;

FIG. 5 is a diagram illustrating an example of a calculation result of scores according to the embodiment; and

FIG. 6 is a block diagram illustrating a schematic configuration example of a retrieving device according to a modification example.

### DETAILED DESCRIPTION

According to an embodiment, a retrieving device includes: a text input unit, a first extracting unit, a retrieving unit, a second extracting unit, an acquiring unit, and a selecting unit. The text input unit inputs a text including unknown word information representing a phrase that a user was unable to transcribe. The first extracting unit extracts related words representing a phrase related to the unknown word information among phrases other than the unknown word information included in the text. The retrieving unit retrieves a related document representing a document including the related words. The second extracting unit extracts candidate words representing candidates for the unknown word information from a plurality of phrases included in the related document. The acquiring unit acquires reading information representing estimated pronunciation of the unknown word information. The selecting unit selects at least one of candidate word of which pronunciation is similar to the reading information among the candidate words.

Hereinafter, embodiments of a retrieving device, a retrieving method, and a computer program product will be described in detail with reference to the accompanying drawings. In the following embodiments, although a personal computer (PC) having a function of reproducing voice data and a text creating function of creating a text in accordance with an operation by a user is described as an example of a retrieving device, the retrieving device is not limited to this. In the following embodiments, when performing a transcribing operation, the user inputs a text by operating a keyboard while reproducing recorded voice data to create the text of the voice data.

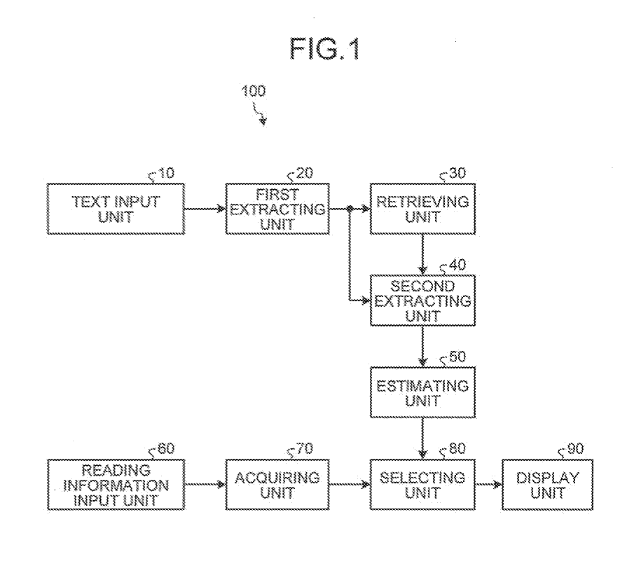

FIG. 1 is a block diagram illustrating a schematic configuration example of a retrieving device 100 according to the present embodiment. As illustrated in FIG. 1, the retrieving device 100 includes a text input unit 10, a first extracting unit 20, a retrieving unit 30, a second extracting unit 40, an estimating unit 50, a reading information input unit 60, an acquiring unit 70, a selecting unit 80, and a display unit 90.

The text input unit 10 inputs a text including unknown word information representing an unknown word which is a phrase (including words and phrases) that a user was unable to transcribe. In the present embodiment, the text input unit 10 has a function of creating a text in accordance with an operation on a keyboard by the user and inputs a created text. The text input unit 10 is not limited to this, and for example, a text creating unit having a function of creating a text in accordance with an operation of the user may be provided separately from the text input unit 10. In this case, the text input unit 10 can receive the text created by the text creating unit and input the received text.

When performing a transcribing operation, the user creates a text by operating a keyboard while reproducing recorded voice data, the user inputs unknown word information representing an unknown word with respect to a phrase of which the pronunciation is not correctly understood and of which the notation (spelling) is unclear. In the present embodiment, although a symbol “•” rather than a phrase is employed as unknown word information, the unknown word information is not limited to this. The type of the unknown word information is optional if it is information representing a phrase (unknown word) that the user was unable to transcribe.

The first extracting unit 20 extracts related words representing a phrase related to the unknown word among phrases other than the unknown word information included in the text input by the text input unit 10. More specifically, the first extracting unit 20 extracts phrases other than the unknown word information included in the text by performing a language processing technique such as morphological analysis on the text input by the text input unit 10. The extracted phrases can be regarded as phrases (audible words) that the user was able to transcribe. Moreover, the first extracting unit 20 extracts a plurality of adjacent phrases appearing before and after the unknown word information among the audible words extracted in this way as the related words. As an example, in the present embodiment, the first extracting unit 20 extracts two adjacent phrases appearing before and after the unknown word information among the extracted audible words as the related words. The related word extracting method is not limited to this.

The retrieving unit 30 retrieves a related document representing a document including the related words. For example, the retrieving unit 30 can retrieve the related document using a known retrieving technique from a document database (not illustrated) provided in the retrieving device 100 or document data available on the World Wide Web (WWW) by using the related words extracted by the first extracting unit 20 as a query word. Moreover, the retrieving unit 30 collects (acquires) a predetermined number of related documents obtained as the result of retrieval.

The second extracting unit 40 extracts candidate words representing candidates for the unknown word from a plurality of phrases included in the related document collected by the retrieving unit 30. This will be described in more detail below. In the present embodiment, the second extracting unit 40 extracts a plurality of phrases included in the related document by performing a language processing technique such as morphological analysis on the related document retrieved by the retrieving unit 30. Moreover, the second extracting unit 40 extracts phrases other than phrases identical to the audible words described above among the plurality of extracted phrases as the candidate words.

The estimating unit 50 estimates information (referred to as “candidate word reading information”) representing the pronunciation (reading) of the candidate words extracted by the second extracting unit 40. As an example, in the present embodiment, the estimating unit 50 can estimate respective candidate word reading information items from the notations (spellings) of the candidate words extracted by the second extracting unit 40 using a known pronunciation estimating technique used in speech synthesis. The candidate word reading information estimated by the estimating unit 50 is delivered to the selecting unit 80.

The reading information input unit 60 inputs reading information representing the estimated pronunciation of the unknown word. In the present embodiment, the user operates a keyboard so as to input a character string representing the pronunciation of the unknown word estimated by the user. Moreover, the reading information input unit 60 generates a character string in accordance with the operation on the keyboard by the user and inputs the generated character string as reading information.

The acquiring unit 70 acquires the reading information. In the present embodiment, the acquiring unit 70 acquires the reading information input by the reading information input unit 60. The reading information acquired by the acquiring unit 70 is delivered to the selecting unit 80.

The selecting unit 80 selects a candidate word of which pronunciation is similar to the reading information acquired by the acquiring unit 70 among the candidate words extracted by the second extracting unit 40. This will be described in more detail below. In the present embodiment, the selecting unit 80 compares the reading information acquired by the acquiring unit 70 with the candidate word reading information of the respective candidate words estimated by the estimating unit 50. Moreover, the selecting unit 80 calculates the degree of similarity between the candidate word reading information and the reading information acquired by the acquiring unit 70 for each of the candidate words. A degree of similarity calculating method is optional, and various known techniques can be used. For example, a method in which an edit distance is calculated in units of mora, a method in which the distance is calculated based on the degree of acoustic similarity in units of monosyllable or the degree of articulatory similarity, or the like may be used. Moreover, the selecting unit 80 selects a predetermined number of candidate words of which degree of similarity is high among the candidate words extracted by the second extracting unit 40.

The display unit 90 displays the candidate words selected by the selecting unit 80. Although not shown in detail, the retrieving device 100 of the present embodiment includes a display device for displaying various types of information. The display device may be configured as a liquid crystal panel, for example. Moreover, the display unit 90 controls the display device such that the display device displays the candidate words selected by the selecting unit 80.

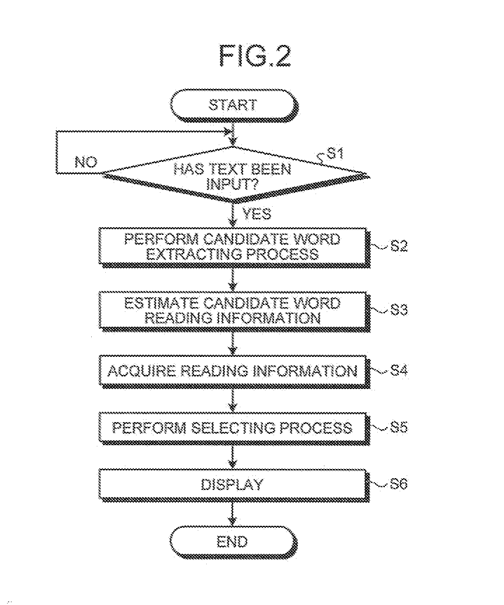

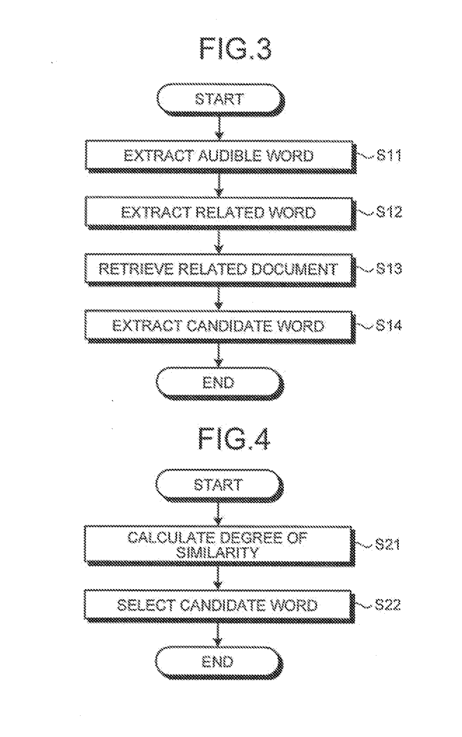

FIG. 2 is a flowchart illustrating an example of the processing operation by the retrieving device 100 of the present embodiment. As illustrated in FIG. 2, when a text including unknown word information (in this example, “•”) is input by the text input unit 10 (YES in step S1), the retrieving device 100 executes a candidate word extracting process of extracting candidate words (step S2). This will be described in more detail below. FIG. 3 is a flowchart illustrating an example of a candidate word extracting process. As illustrated in FIG. 3, first, the first extracting unit 20 extracts phrases (audible words) other than the unknown word information included in the text by performing a language processing technique such as morphological analysis on the text input by the text input unit 10 (step S11). Subsequently, the first extracting unit 20 extracts two adjacent phrases appearing before and after the unknown word information among the audible words extracted in step S11 (step S12).

Subsequently, the retrieving unit 30 retrieves a related document representing a document including the related words (step S13). Subsequently, the second extracting unit 40 extracts candidate words from a plurality of phrases included in the related document retrieved in step S13 (step S14). As described above, in the present embodiment, the second extracting unit 40 extracts a plurality of phrases included in the related document and extracts phrases other than phrases identical to the audible words among the extracted phrases as candidate words by performing a language processing technique such as morphological analysis on the related document retrieved in step S13. This is how the candidate word extracting process is performed.

The description will be continued by returning to FIG. 2. After the candidate word extracting process described above (after step S2), the estimating unit 50 estimates candidate word reading information of each of the plurality of candidate words extracted in step S2 (step S3). Subsequently, the acquiring unit 70 acquires reading information input by the reading information input unit 60 (step S4). Subsequently, the selecting unit 80 executes a selecting process of selecting candidate words to be displayed (step S5). This will be described in more detail below.

FIG. 4 is a flowchart illustrating an example of a selecting process executed by the selecting unit 80. As illustrated in FIG. 4, first, the selecting unit 80 compares the reading information acquired in step S4 with the candidate word reading information of the respective candidate words estimated in step S3 and calculates the degree of similarity between the candidate word reading information of the candidate word and the reading information acquired in step S4 for each of the candidate words (step S21). Subsequently, the selecting unit 80 selects a predetermined number of candidate words of which degree of similarity calculated in step S21 is high among the candidate words extracted in step S2 (step S22). This is how the selecting process is performed.

The description will be continued by returning to FIG. 2. After the selecting process described above (after step S5), the display unit 90 controls a display device such that the display device displays the candidate words selected in step S4 (step S6). For example, the user viewing the displayed content may select any one of the candidate words, so that the portion of the unknown word information in the input text may be replaced with the selected candidate word. In this way, it is possible to improve the efficiency of a transcribing operation.

As a specific example, a case in which a text “ [symbol] [symbol] [symbol] [symbol] (pronounced in Japanese as ‘sakihodomo mousiage masita toori, sonoyouna kyouikuhou, • nadono kiteino nakani’)” is input by the text input unit 10, and reading information (a character string representing the estimated reading of the unknown word) ‘sijuzutsu gakkouhou’ is input by the reading information input unit 60 will be considered. In this case, the user estimates that the pronunciation (reading) of the portion described by “•” in the text is “sijuzutsu gakkouhou” and the retrieving device 100 retrieves candidate words for the phrase of the “•” portion.

First, when a text “ [symbol] [symbol] [symbol] [symbol] (pronounced in Japanese as ‘sakihodomo mousiage masita toori, sonoyouna kyouikuhou, • nadono kiteino nakani’)” is input by the text input unit 10 (YES in step S1 of FIG. 2), the candidate word extracting process described above is executed (step S2 of FIG. 2). In this example, the first extracting unit 20 extracts “ [symbol] (pronounced in Japanese as ‘sakihodo’),” “ [symbol] (pronounced in Japanese as ‘mousi age masita’),” “ [symbol] (pronounced in Japanese as ‘tooti’),” “ [symbol] (pronounced in Japanese as ‘kyouiku-hou’),” “ [symbol] (pronounced in Japanese as ‘kitei’),” and “ [symbol] (pronounced in Japanese as ‘naka’)” included in the text as audible words by performing a language processing technique such as morphological analysis on the input text “ [symbol] [symbol] [symbol] [symbol] (pronounced in Japanese as ‘sakihodomo mousiage masita toori, sonoyouna kyouikuhou, • nadono kiteino nakani’)” (step S11 of FIG. 3). Moreover, the first extracting unit 20 extracts two phrases “ [symbol] (pronounced in Japanese as ‘kyouiku-hou’)” and “ [symbol] (pronounced in Japanese as ‘kitei’)” adjacent to “•” which is the unknown word information among the extracted audible words as related words (step S12 of FIG. 3). Subsequently, the retrieving unit 30 retrieves a related document using a known Web search engine by using the phrases “ [symbol] (pronounced in Japanese as ‘kyouiku-hou’)” and “ [symbol] (pronounced in Japanese as ‘kitei’)” extracted as the related words as a query word (step S13 of FIG. 3). In this way, the retrieving unit 30 collects a predetermined number of related documents obtained as the result of the retrieval.

Subsequently, the second extracting unit 40 extracts a plurality of phrases such as “ [symbol] [symbol] (pronounced in Japanese as ‘gakkou kyouiku sikou kisoku’),” “ [symbol] (pronounced in Japanese as ‘showa’),” “ [symbol] (pronounced in Japanese as ‘gakkou’),” “ [symbol] (pronounced in Japanese as ‘kyouiku-ho’),” “ [symbol] (pronounced in Japanese as ‘kitei’),” “ [symbol] (pronounced in Japanese as ‘kouchi’),” “ [symbol] (pronounced in Japanese as ‘youchi-en’),” “ [symbol] (pronounced in Japanese as ‘kyouin’),” and “ [symbol] (pronounced in Japanese as ‘siritu gakkou-hou’)” included in the related document by performing a language processing technique such as morphological analysis on the text portion of the related document collected by the retrieving unit 30. Moreover, the second extracting unit 40 extracts phrases (phrases such as “ [symbol] [symbol] ,” “ [symbol] ,” “ [symbol] ,” “ [symbol] ,” “ [symbol] ,” “ [symbol] ,” and “ [symbol] ” (each pronounced in Japanese as ‘gakkou kyouiku-hou sikou kisoku,’ ‘showa,’ ‘gakkou,’ ‘kouchi,’ ‘youchi-en,’ ‘kyouin,’ and ‘shiritu gakkou-hou’)) other than phrases identical to audible words (“ [symbol] ,” “ [symbol] ,” “ [symbol] ,” “ [symbol] ,” “ [symbol] ,” and “ [symbol] ” (each pronounced in Japanese as ‘sakihodo,’ ‘moushi agemasita,’ ‘toori,’ ‘kyouiku-ho,’ ‘kitei,’ and ‘naka’)) among the extracted phrases as candidate words (step S14 of FIG. 3).

Subsequently, the estimating unit 50 estimates respective candidate word reading information of the extracted candidate words by performing a known pronunciation estimating process used in a speech synthesis technique on the extracted candidate words (step S3 of FIG. 2). In this example, “ [symbol] [symbol] (pronounced in Japanese as ‘gakkou kyouiku sikou kisoku’)” is estimated as the candidate word reading information of the candidate word “ [symbol] [symbol] ”. Similarly, “ [symbol] (pronounced in Japanese as ‘showa’)” is estimated as the candidate word reading information of the candidate word “ [symbol] ”. Similarly, “ [symbol] (pronounced in Japanese as ‘gakkou’)” is estimated as the candidate word reading information of the candidate word “ [symbol] ”. Similarly, “ [symbol] ” is estimated as the candidate word reading information of the candidate word “ [symbol] ”. Similarly, “ [symbol] (pronounced in Japanese as ‘youchi-en’)” is estimated as the candidate word reading information of the candidate word “ [symbol] ”. Similarly, “ [symbol] (pronounced in Japanese as ‘kyouin’)” is estimated as the candidate word reading information of the candidate word “ [symbol] ”. Similarly, “ [symbol] [symbol] (pronounced in Japanese as ‘siritu gakkou-hou’)” is estimated as the candidate word reading information of the candidate word “ [symbol] ”.

Subsequently, the acquiring unit 70 acquires the reading information “ [symbol] [symbol] (pronounced in Japanese as ‘sijuzutu gakkou-hou’)” input by the reading information input unit 60 (step S4 of FIG. 2). Moreover, the selecting unit 80 calculates the degree of similarity between the reading information “ [symbol] [symbol] (pronounced in Japanese as ‘sijuzutu gakkou-hou’)” acquired by the acquiring unit 70 and each of the candidate word reading information items “ [symbol] [symbol] (pronounced in Japanese as ‘gakkou kyouiku sikou kisoku’),” “ [symbol] (pronounced in Japanese as ‘showa’),” “ [symbol] (pronounced in Japanese as ‘gakkou’),” “ [symbol] (pronounced in Japanese as kouchi),” “ [symbol] (pronounced in Japanese as ‘youchi-en’),” “ [symbol] (pronounced in Japanese as ‘kyouin’),” and “ [symbol] [symbol] (pronounced in Japanese as ‘siritu gakkou-hou’)” of the respective candidate words estimated by the estimating unit 50 (step S21 of FIG. 4). In this example, the degree of similarity is obtained by calculating the edit distance between the reading information and the candidate word reading information in units of mora. For example, if it is defined that a substitution cost is 2 and a deletion/insertion cost is 1, the scores representing the degrees of similarity between the reading information “ [symbol] [symbol] (pronounced in Japanese as ‘sijuzutu gakkou-hou’)” and the respective candidate word reading information items are calculated as follows. The candidate word reading information “ [symbol] [symbol] (pronounced in Japanese as ‘gakkou kyouiku sikou kisoku’)” has a score of 16, the candidate word reading information “ [symbol] (pronounced in Japanese as ‘showa’)” has a score of 11, the candidate word reading information “ [symbol] (pronounced in Japanese as ‘gakkou’)” has a score of 7, the candidate word reading information “ [symbol] (pronounced in Japanese as ‘kouchi’)” has a score of 10, the candidate word reading information “ [symbol] (pronounced in Japanese as ‘youchi-en’)” has a score of 14, the candidate word reading information “ [symbol] (pronounced in Japanese as ‘kyouin’)” has a score of 14, and the candidate word reading information “ [symbol] [symbol] (pronounced in Japanese as ‘siritu gakkou-hou’)” has a score of 4. In this example, the smaller the value of the score is, the closer the pronunciation represented by the candidate word reading information is (has a higher degree of similarity) to the pronunciation represented by the reading information.

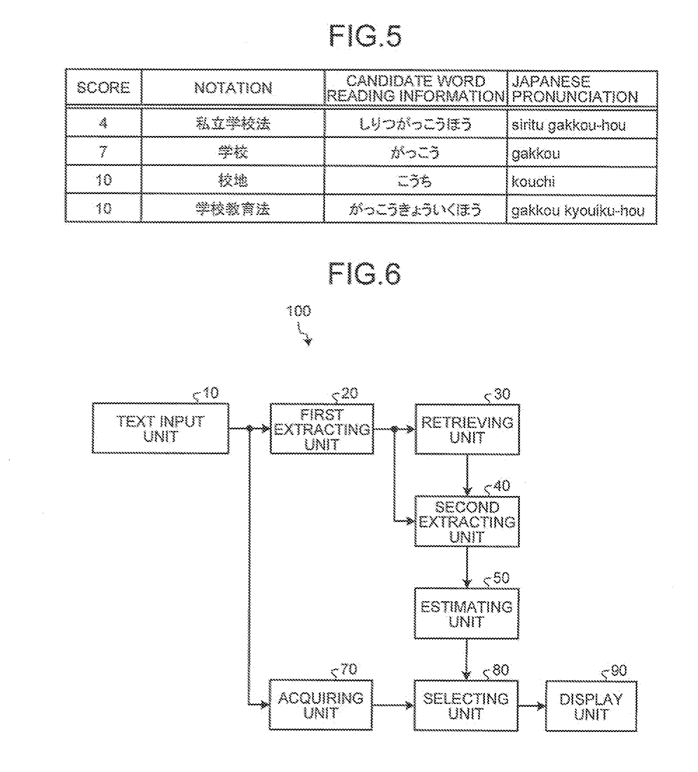

Subsequently, the selecting unit 80 selects a predetermined number of candidate words of which value of the score is small (that is, the degree of similarity is high) among the candidate words (step S22 of FIG. 4). In this example, as illustrated in FIG. 5, four candidate words “ [symbol] ( [symbol] [symbol] ) (pronounced in Japanese as ‘siritu gakkou-hou’),” “ [symbol] ) (pronounced in Japanese as ‘gakkou’),” “ [symbol] ( [symbol] ) (pronounced in Japanese as ‘kouchi’),” and “ [symbol] ( [symbol] [symbol] ) (pronounced in Japanese as ‘siritu gakkou-hou’)” are selected in ascending order of the values of the scores. Subsequently, the display unit 90 controls the display device so as to display a set of a notation (spelling) and candidate word reading information representing pronunciation (reading) of the four candidate words selected by the selecting unit 80 in ascending order of scores (step S6 of FIG. 2).

As described above, in the present embodiment, since candidate words representing the candidates for an unknown word are extracted from a related document including phrases (related words) related to the unknown word information among the phrases other than the unknown word information included in the input text, it is possible to prevent phrases of which only pronunciation is similar to the unknown word and which are not related to the unknown word from being displayed as candidate words. In the specific example described above, phrases of which only pronunciation is similar to the unknown word and which are completely not related to “ [symbol] (pronounced in Japanese as ‘gakkou’)” and “ [symbol] (pronounced in Japanese as ‘kyouiku’)” which are a related field of the unknown word, such as “ [symbol] ( [symbol] ) (pronounced in Japanese as ‘shujutu’)” and “ [symbol] ( [symbol] [symbol] ) (pronounced in Japanese as ‘shujutu kyouiku’)” having score values of “7” and “11,” respectively, representing the degrees of similarity to the reading information “ [symbol] [symbol] (pronounced in Japanese as ‘sijuzutu gakkou-hou’)” are prevented from being displayed as the result of the retrieval.

The retrieving device according to the embodiment can be realized by using a general-purpose computer device (for example, a PC) as basic hardware. That is, each of the text input unit 10, the first extracting unit 20, the retrieving unit 30, the second extracting unit 40, the estimating unit 50, the reading information input unit 60, the acquiring unit 70, the selecting unit 80, and the display unit 90 can be realized by a CPU mounted in the computer device executing a program stored in a ROM or the like. The present invention is not limited to this, and at least part of the text input unit 10, the first extracting unit 20, the retrieving unit 30, the second extracting unit 40, the estimating unit 50, the reading information input unit 60, the acquiring unit 70, the selecting unit 80, and the display unit 90 may be configured as a hardware circuit.

Moreover, the retrieving device may be realized by installing the program in advance in a computer device, and may be realized by storing the program in a storage medium such as a CD-ROM or being distributed with the program through a network and installing the program appropriately in a computer device. Moreover, if various data files used for using a language processing technique or a pronunciation estimating technique are required, a storage medium storing these files may be realized by appropriately using a memory integrated into or externally attached to the computer device, a hard disk, a CD-R, a CD-RW, a DVD-RAM, a DVD-R, or the like.

While certain embodiments have been described, these embodiments have been presented by way of example only, and are not intended to limit the scope of the inventions. Indeed, the novel device, method, and program described herein may be embodied in a variety of other forms; furthermore, various exclusions, substitutions, and changes in the form of the device, method, and program described herein may be made without departing from the spirit of the inventions. The accompanying claims and their equivalents are intended to cover such forms or modifications as would fall within the scope and spirits of the inventions. Moreover, a configuration excluding the display unit 90 from all of the entire constituent components (the text input unit 10, the first extracting unit 20, the retrieving unit 30, the second extracting unit 40, the estimating unit 50, the reading information input unit 60, the acquiring unit 70, the selecting unit 80, and the display unit 90) described in the embodiment described above, for example, can be grasped as the retrieving device according to the invention. That is, various inventions can be formed by an appropriate combination of the plurality of constituent components disclosed in the embodiment described above.

Modification examples will be described below. The following modification examples can be combined in an optional manner.

### (1) Modification Example 1

In the embodiment described above, although the acquiring unit 70 acquires the reading information input by the reading information input unit 60, the embodiment is not limited to this, and a method of acquiring reading information by the acquiring unit 70 is optional. For example, the unknown word information included in the text input by the text input unit 10 may be configured to include reading information, and the acquiring unit 70 may extract and acquire the reading information from the unknown word information included in the text input by the text input unit 10. In this case, the reading information input unit 60 is not necessary as illustrated in FIG. 6.

For example, the unknown word information may be configured to include a character string representing reading information and a specific symbol added before and after the character string. For example, in the specific example described above, the unknown word information included in the text may be represented as < [symbol] [symbol] > (pronounced in Japanese as ‘shijuzutu gakkou-hou’ [symbol] r) instead of •. That is, a text “ [symbol] [symbol] , [symbol] [symbol] , < [symbol] [symbol] > [symbol] [symbol] (pronounced in Japanese as ‘sakihodomo mousi agemasita toori, sonoyouna kyouiku-hou, <sijuzutu gakkou-hou> nadono kiteino nakani’)” may be input by the text input unit 10, and the acquiring unit 70 may acquire the reading information “ [symbol] [symbol] (pronounced in Japanese as ‘sijuzutu gakkou-hou’)” from the unknown word information < [symbol] [symbol] > (pronounced in Japanese as ‘sijuzutu gakkou-hou’) included in the text.

### (2) Modification Example 2

In the embodiment described above, although the first extracting unit 20 extracts a plurality of (for example, two) adjacent phrases appearing before and after the unknown word information among the extracted audible words as related words, the invention is not limited to this. For example, the first extracting unit 20 may extract phrases of which occurrence frequency is high among phrases (audible words) other than the unknown word information included in the input text as related words. For example, audible words of which occurrence frequency is on a predetermined rank or higher or of which occurrence frequency is a predetermined value or greater may be extracted as related words. That is, the first extracting unit 20 may extract phrases related to the unknown word among the audible words as related words.

### (3) Modification Example 3

In the specific example described above, although the selecting unit 80 calculates the degree of similarity of pronunciation using an edit distance calculated in units of mora using a phonogram as hiragana, the respective moras may be substituted with phoneme symbols or monosyllabic symbols, and the degree of similarity of pronunciation may be obtained by calculating an edit distance in units of symbol. Moreover, the degree of similarity of pronunciation may be calculated by referring to a table describing the degree of similarity of pronunciation between phonograms (phoneme symbols, monosyllabic symbols, or the like).

### (4) Modification Example 4

In the embodiment described above, although the retrieving unit 30 retrieves the related document using a known retrieving technique from a document database (not illustrate) provided in the retrieving device 100 or document data available on the world wide web (WWW) by using the related words extracted by the first extracting unit 20 as a query word, but not limited to this, the related document retrieving method is optional. For example, a related document storage unit storing dedicated document files may be included in the retrieving device 100, and a document (related document) including the related words extracted by the first extracting unit 20 may be retrieved.

### (5) Modification Example 5

In the embodiment described above, although the second extracting unit 40 excludes phrases identical to the audible words among the plurality of phrases included in the related document from the candidate words, the invention is not limited to this. For example, a plurality of phrases included in the related document may be extracted as the candidate words rather than excluding phrases identical to the audible words among the plurality of phrases included in the related document from the candidate words. However, as in the case of the embodiment described above, by excluding phrases identical to the audible words among the plurality of phrases included in the related document from the candidate words, it is possible to further narrow down the candidate words as compared to extracting the plurality of phrases included in the related document as the candidate words.

### (6) Modification Example 6

In the embodiment described above, although the language (a language subjected to the transcribing operation) of the text input to the retrieving device 100 is Japanese, the language is not limited to this, and the type of the language of the input text is optional. For example, the language of the input text may be English and may be Chinese. Even when the language of the input text is English or Chinese, the same configuration as that for Japanese is applied.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A retrieving device comprising:
a text input unit configured to input a text including unknown word information representing a phrase that a user was unable to transcribe;
a first extracting unit configured to extract related words representing a phrase related to the unknown word information among phrases other than the unknown word information included in the text;
a retrieving unit configured to retrieve a related document representing a document including the related words;
a second extracting unit configured to extract candidate words representing candidates for the unknown word information from a plurality of phrases included in the related document;
an acquiring unit configured to acquire reading information representing estimated pronunciation of the unknown word information; and
a selecting unit configured to select at least one of candidate word of which pronunciation is similar to the reading information among the candidate words.

2. The device according to claim 1,
wherein the second extracting unit excludes phrases identical to phrases other than the unknown word information included in the text among the plurality of phrases included in the related document from the candidate words.

3. The device according to claim 1, further comprising
a reading information input unit configured to input the reading information,
wherein the acquiring unit acquires the reading information input by the reading information input unit.

4. The device according to claim 1,
wherein the unknown word information is configured to include the reading information, and
wherein the acquiring unit extracts and acquires the reading information from the unknown word information included in the text.

5. The device according to claim 1,
wherein the first extracting unit extracts phrases of which occurrence frequency is high among phrases other than the unknown word information included in the text as the related words.

6. The device according to claim 1,
wherein the first extracting unit extracts a plurality of adjacent phrases appearing before and after the unknown word information among phrases other than the unknown word information included in the text as the related words.

7. The device according to claim 1, further comprising
a display unit configured to display the candidate words selected by the selecting unit.

8. A retrieving method comprising:
inputting a text including unknown word information representing a phrase that a user was unable to transcribe;
first extracting that includes extracting related words representing a phrase related to the unknown word information among phrases other than the unknown word information included in the text;
retrieving a related document representing a document including the related words;
second extracting that includes extracting candidate words representing candidates for the unknown word information from a plurality of phrases included in the related document;
acquiring reading information representing estimated pronunciation of the unknown word information; and
selecting at least one of candidate word of which pronunciation is similar to the reading information among the candidate words.

9. A computer program product comprising a computer-readable medium including programmed instructions for retrieving, wherein the instructions, when executed by a computer, cause the computer to perform:
inputting a text including unknown word information representing a phrase that a user was unable to transcribe;
first extracting that includes extracting related words representing a phrase related to the unknown word information among phrases other than the unknown word information included in the text;
retrieving a related document representing a document including the related words;
second extracting that includes extracting candidate words representing candidates for the unknown word information from a plurality of phrases included in the related document;
acquiring reading information representing estimated pronunciation of the unknown word information; and
selecting at least one of candidate word of which pronunciation is similar to the reading information among the candidate words.
